(19) United States
(12) Patent Application Publication
(10) Pub. No.: US 2010/0063941 A1
(43) Pub. Date: Mar. 11, 2010

(54) INFLATION-INDEXED PAYMENT STREAM PROCESSOR

(75) Inventor: Allan N. Weiss, Medfield, MA (US)

Correspondence Address: MILLS & ONELLO LLP, ELEVEN BEACON STREET, SUITE 605, BOSTON, MA, 02108, US

(73) Assignee: MARKET SHIELD CAPITAL, LLC, Natick, MA (US)

(21) Appl. No.: 12/620,275

(22) Filed: Nov. 17, 2009

Related U.S. Application Data
(63) Continuation-in-part of application No. 11/553,150, filed on Oct. 26, 2006.
Application No. 11/553,150 is a continuation of application No. 10/794,465, filed on Mar. 5, 2004, now Pat. No. 7,155,468.
(60) Provisional application No. 61/115,327, filed on Nov. 17, 2008.
(60) Provisional application No. 60/453,075, filed on Mar. 7, 2003.

(51) Int. Cl. G06Q 40/00

(52) U.S. Cl. 705/36 R

(57) ABSTRACT

A system and method for performing inflation indexing is provided. The system comprises an inflation indexing processor configured to calculate a payment stream from a set of information including a liquidity value. An inflation component processor is configured to retrieve one or more inflation components or aggregate individual transactions in order to calculate the inflation components and to generate an inflation index therefrom. And a payment adjustment processor is configured to adjust the payment stream using the inflation index. Inflation indexed payment streams can be aggregated into a fund, against which shares may be defined and traded.

### CROSS REFERENCES TO RELATED APPLICATIONS

This application claims the benefit of priority under 35 U.S.C. §119(e) from co-pending, commonly owned U.S. provisional patent application Ser. No. 60/915,790, entitled INFLATION-INDEXED PAYMENT STREAM PROCESSOR, filed Nov. 17, 2008. This application is a continuation-in-part of co-pending, commonly owned U.S. non-provisional patent application Ser. No. 11/553,150, entitled COMMON INDEX SECURITIES, filed Oct. 26, 2006, which is a continuation application of U.S. patent application Ser. No. 10/794,465, filed Mar. 5, 2004, entitled COMMON INDEX SECURITIES, now U.S. Pat. No. 7,155,468, which claimed priority under 35 U.S.C. §119(e) to U.S. Provisional Patent Application Ser. No. 60/453,075, entitled SMALL BUSINESS LIQUID SECURITIES, filed Mar. 7, 2003, each of which is hereby incorporated by reference.

### FIELD OF INTEREST

The present inventive concepts relate to systems and methods for processing and transforming information in the field of finance.

### BACKGROUND

Presently, there are few vehicles that enable investors to easily and efficiently insulate themselves against inflation. Many systems exist that allow investors to invest in all sorts of equities, bonds, funds and so on. But most of these investments have no direct correlation to inflation itself.

Treasury inflation-protected securities (TIPS) and, for example, Series I Savings Bonds represent two types of existing investments that do claim to offer an investment that tracks Consumer Price Index (CPI), as a measure of inflation. These are traditional investments in many respects, in that an investor can buy and sell TIPS securities and Series I Bonds as they would other types of securities and bonds. These investments are adjusted up and/or down according to movements of published CPI, i.e., by a factor of one times CPI.

TIPS and CPI indexed bonds are useful for those investors looking for a place to put their money that will be presumably protected against inflation. For example, a couple close to retirement might find these types of investments very attractive. That is, they can allow an investor to have an amount of their existing cash protected against being devalued over time by inflation.

However, these types of investments do not provide any utility for entities with a need to obtain or raise new capital and/or to have the repayment of capital indexed to inflation. And, to date, a structure that returns inflation, or multiples of inflation, to lenders or entities providing a predetermined amount of capital to another entity have not been conceived of. Such concepts are heretofore unknown.

### SUMMARY

In accordance with one aspect of the present disclosure, provided is a system for performing inflation indexing. The system comprises an inflation indexing processor configured to calculate a payment stream from a set of information including a stored initial liquidity value or balance; an inflation component processor configured to retrieve one or more inflation components and to generate an inflation index therefrom; and a payment adjustment processor configured to adjust the payment stream and balance using the inflation index.

The payment stream could be adjusted using the inflation index to effectively result in an interest rate needed to maintain an amortization rate.

The initial liquidity value can represent upfront liquidity provided to an entity represented in memory.

The payment stream can also represent at least one other payment to be distributed after the upfront liquidity.

The one or more inflation components can be a single component representing CPI.

The one or more inflation components can be a plurality of CPI components.

The system can further comprise a fund system configured to logically aggregate inflation indexed payments streams into a fund.

The fund system can be configured to define shares as claims against the value of the fund.

The fund system can be configured to trade at least some of the shares.

The fund system can be configured to adjust the value of the shares based on changes in the inflation index.

The fund system can be configured to determine a fund value.

In accordance with another aspect of the present disclosure, provided is a computer-based method for performing inflation indexing. The method comprises calculating a payment stream from a set of information including a stored initial liquidity value or balance; retrieving one or more inflation components and generating an inflation index therefrom; and adjusting the payment stream and balance using the inflation index as well as, possibly, a resulting interest rate needed to maintain an amortization rate.

The initial liquidity value can represent upfront liquidity provided to an entity represented in memory.

The payment stream can also represent at least one other payment to be distributed after the upfront liquidity.

The one or more inflation components can be a single component representing CPI.

The one or more inflation components can be a plurality of CPI components.

The method can further comprise logically aggregating inflation indexed payments streams into a fund.

The method can include defining shares as claims against the value of the fund.

The method can include trading at least some of the shares.

The method can be include adjusting the value of the shares based on changes in the inflation index.

The method can include determining a fund value.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a is a top level embodiment of a computer architecture which could be used to implement a system in accordance with the present invention;

FIG. 2 is a block diagram of an embodiment of elements of the architecture of FIG. 1; and

FIG. 3 is a block diagram of an embodiment of an inflation indexing system with the formation of a fund, in accordance with aspects the present invention.

### DETAILED DESCRIPTION OF PREFERRED EMBODIMENTS

Hereinafter, aspects of the present invention will be described by explaining illustrative embodiments in accordance therewith, with reference to the attached drawings. While describing these embodiments, detailed descriptions of well-known items, functions, or configurations are typically omitted for conciseness.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

In accordance with the invention, provided is a system and computer-implemented method that uniquely provide insulation against inflation. Values in the computer-implemented method are stored in memory, can be packaged and transmitted across various networks, and are transformed by a processor to generate new values and displays of computer generated information.

Any of a variety of types of entities can receive liquidity in return for paying making one or more payments that are indexed, at least in part, to inflation. For example, an entity can be a “small business,” as defined by certain agencies or governmental regulations based on criteria relating to the size of the business, such as its number of employees, gross revenue, and so on. The phrase “small business” as used herein can also include businesses or entities not traded or traditionally tradable as a liquid security, such as: (1) any entity which is generally considered by the financial community as not suitable for an initial public offering (IPO) or public trading, (2) any entity which was once publicly traded, but has since been de-listed, (3) a subsidiary or affiliate of a business, even if that business is traded publicly or privately, (4) any other entity not publicly traded, regardless of size, or profitability, (5) one or more individuals or entities having a source of income, (6) a partnership or joint venture, (7) a university or not-for-profit organization, (8) a trust, (9) a company that is already publicly traded, or (10) any combination of the foregoing. As examples, a start-up company, an educational institution, a not for profit or charitable institution, or individual or group of individuals may each be a “small business” within the context of the present invention. Notwithstanding, an entity need not be a small business as described above.

As discussed below, using an inventive inflation index processor there are different approaches to countering the effects of inflation that fall within the scope of the invention.

In the exemplary embodiments, there can be three parameters that can have different states used in processing values: (1) Upfront Liquidity; (2) Multiple of Inflation; and (3) Inflation from Components. As will be appreciated by those skilled in the art, CPI means Consumer Price Index published by the Department of Labor in the United States. CPI is used herein as a measure or indication of the rate of inflation.

For each parameter there can be at least two states. In the present embodiment there are two states for each, which can be represented as “Yes” or “No” values (or “1” or “0” in binary).

For example, in the present embodiment, for the Upfront Liquidity parameter a “Yes” means there is a one-time payment made to an entity. And a “No” means there are one or more additional payments made at a later time.

For example, in the present embodiment, for the Multiple of Inflation parameter a “Yes” means inflation (or CPI) times a number greater than one. And a “No” means inflation (or CPI) times 1.

For example, in the present embodiment, for the Inflation from Components parameter a “Yes” means an aggregate investment is created which is comprised of multiple payment streams from one or more entities each of which varies with one or more components of inflation, such as electricity costs, oil costs, or rent of primary residence costs, as examples. Such investments can be aggregated to form of a fund. And a “No” means payment stream from the entity is defined that includes payments by the entity of inflation or a component of inflation, which is not aggregated into a fund.

In this disclosure, combinations of the above stated parameters are considered as embodiments in accordance with the present invention, as indicated in Table 1 below.

TABLE 1

| | UPFRONT | MULTIPLE OF | INFLATION FROM |
|---|---|---|---|
| | LIQUIDITY | INFLATION | COMPONENTS |
| 1. | Yes | Yes | Yes |
| 2. | No | Yes | Yes |
| 3. | Yes | Yes | No |
| 4. | Yes | No | Yes |
| 5. | No | Yes | No |
| 6. | No | No | Yes |

Each of the embodiment combinations from Table 1 will now be described.

Embodiment 1. This embodiment answers Yes to each of the 3 parameters: Upfront Liquidity, Multiple of Inflation, and Inflation from Components.

In this embodiment, a one-time payment is made to an entity, so there is full upfront liquidity.

A payment stream from the entity is defined that includes payments by the entity of a multiple of inflation (meaning inflation times a number greater or less than one). In some embodiments, the payments could comprise two components in which each of the two payments may not include a multiple of inflation however, one component receives inflation or a multiple of inflation and the other receives no inflation or a smaller amount of inflation relative to the component's value. The multiple of inflation can be defined as the payment on the first component plus the payment on the second component divided by the payment on the second component. Inflation can mean all of inflation or a component of inflation.

An aggregate investment can be created which is comprised of multiple payment streams from one or more entity each of which varies with a component or all of inflation, such as electricity costs, oil costs, or rent of primary residence costs as examples. The aggregate investment could take the form of a fund.

Embodiment 2. This embodiment answers Yes to 2 of the 3 parameters: Multiple of Inflation and Inflation from Components, but answers No to the Upfront Liquidity parameter.

In this embodiment, an initial payment may or may not be made to an entity at the start. And, in either case, one or more payments are made to the entity at a later time, after the start. Thus, there is partial or no upfront liquidity.

A payment stream from the entity is defined that includes payments by the entity of a multiple of inflation (meaning inflation times a number greater or less than one). In some embodiments, the payments could comprise two components in which each of the two payments may not include a multiple of inflation however, one component receives inflation or a multiple of inflation and the other receives no inflation or a smaller amount of inflation relative to the component's value. The multiple of inflation can be defined as the payment on the first component plus the payment on the second component divided by the second component. Inflation can mean all of inflation or a component of inflation.

An aggregate investment can be created which is comprised of multiple payment streams from one or more entity each of which varies with a component or all of inflation, such as electricity costs, oil costs, or rent of primary residence costs as examples. The aggregate investment could take the form of a fund.

Embodiment 3. This embodiment answers Yes to 2 of the 3 parameters: Multiple of Inflation and Upfront Liquidity, but answers No to the Inflation from Components parameter.

In this embodiment, a one-time payment is made to an entity, so there is full upfront liquidity.

A payment stream from the entity is defined that includes payments by the entity of a multiple of inflation (meaning inflation times a number greater or less than one). In some embodiments, the payments could comprise two components in which each of the two payments may not include a multiple of inflation however, one component receives inflation or a multiple of inflation and the other receives no inflation or a smaller amount of inflation relative to the component's value. The multiple of inflation can be defined as the payment on the first component plus the payment on the second component divided by the payment on the second component. Inflation can mean all of inflation or a component of inflation.

Embodiment 4. This embodiment answers Yes to 2 of the 3 parameters: Inflation from Components and Upfront Liquidity, but answers No to the Multiple of Inflation parameter.

In this embodiment, a one-time payment is made to an entity, so there is full upfront liquidity.

A payment stream from the entity is defined that includes payments by the entity of 1 times inflation or a component of inflation.

An aggregate investment can be created which is comprised of multiple payment streams from one or more entity each of which varies with a component of or all of inflation, such as electricity costs, oil costs, or rent of primary residence costs as examples. The aggregate investment could take the form of a fund.

Embodiment 5. This embodiment answers No to 2 of the 3 parameters: Upfront Liquidity and Inflation from Components, but answers Yes to the Multiple of Inflation parameter.

In this embodiment, an initial payment may or may not be made to an entity at the start. And, in either case, one or more payments are made to the entity at a later time, after the start. Thus, there is partial or no upfront liquidity.

A payment stream from the entity is defined that includes payments by the entity of a multiple of inflation (meaning inflation times a number greater or less than one). In some embodiments, the payments could comprise two components in which each of the two payments may not include a multiple of inflation however, one component receives inflation or a multiple of inflation and the other receives no inflation or a smaller amount of inflation relative to the component's value. The multiple of inflation can be defined as the payment on the first component plus the payment on the second component divided by the payment on the second component. Inflation can mean all of inflation or a component of inflation.

Embodiment 6. This embodiment answers No to 2 of the 3 parameters: Multiple of Inflation and Upfront Liquidity, but answers Yes to the Inflation from Components parameter.

In this embodiment, an initial payment may or may not be made to an entity at the start. And, in either case, one or more payments are made to the entity at a later time, after the start. Thus, there is partial or no upfront liquidity.

A payment stream from the entity is defined that includes payments by the entity of 1 times inflation or a component of inflation.

An aggregate investment can be created which is comprised of multiple payment streams from one or more entity each of which varies with a component or all of inflation, such as electricity costs, oil costs, or rent of primary residence costs as examples. The aggregate investment could take the form of a fund.

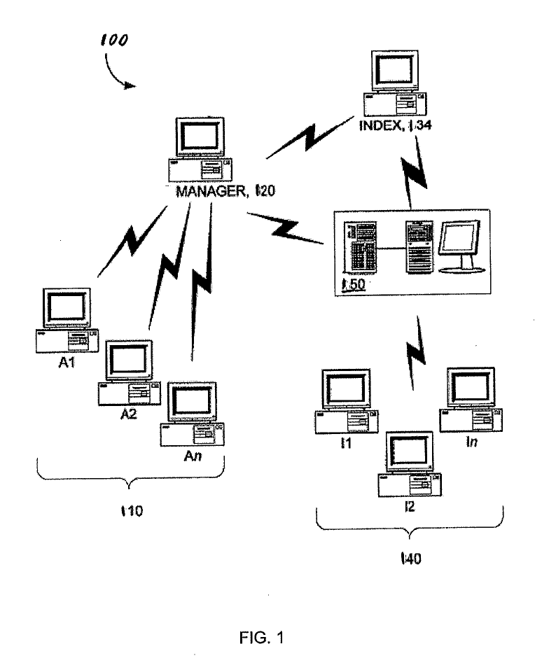

FIG. 1 provides a possible architecture 100 for implementing a system and method for processing and transforming financial data to counter effects of inflation. In this embodiment, a manager system 120 can server as the primary data collection, processing and calculation system. Manager system 120 can interact with client systems A1, A2, . . . An (collectively 110) across any number of types of networks. Systems 110 can represent investing (or lending) entities, investment (which could mean borrowing or some other form of investment) receiving entities, funds transfer entities, and so on. For example, entity Al could be an entity receiving full or partial upfront liquidity, entity A2 could be an entity that receives a part of a payment stream from Al that is not indexed to inflation, and entity An could be an entity that receives a part of the payment stream from A1 that is indexed to inflation. The inflation index, which can be CPI or one or more components of CPI, is electronically provided to the manager system 120 via an index system 134.

Therefore, manager system 120 must be uniquely configured to receive and store data representing loan amounts, liquidity amounts, index values and any other necessary information. Manager system 120 must also be configured to operate on the data to generate new payment values taking appropriate CPI information as inputs. These new payment values are then communicated to client A1, for example, as a new payment obligation. The payment obligation could additionally, or alternatively, be communicated to a payment system that is configured to perform an electronic funds transfer for the payment amount to satisfy the new payment obligation. Payments, payment values, principal amounts, share values and so on are representations of cash.

A fund system 150 can be provided that enables the inflation indexed payment streams to be pooled (or aggregated) as an investment that, by its nature, is indexed to inflation, e.g., as represented by CPI or one or more components thereof. Depending on the embodiment, the fund system 150 can manage the aggregation, issue shares against the fund, and participate in the trading (e.g., buying and selling) of those shares. The fund system 150 could also transform fund data to continually or periodically adjust the monetary value of the fund and its shares. Investors 140 could interact with fund system 150 using devices I1, I2, . . . In.

In various embodiments manager system 120 and fund system 150 may be combined or, if separate, the functions may be distributed differently.

The index system 134 can be configured to access indexes or sources of information useful for generating or recreating indexes. The manager system 120 can be configured to send out payment requirements to entities collecting payments. The fund system 150 and/or the index system 134 can be configured to aggregate indexes. The fund system 150 can also be configured to make appropriate payments to investors, e.g., which may have bought fund shares representing indexes with different weights and components.

While computers are generally represented as desktop computers, the invention is not so limited. A computer can take any of a variety of forms, including, but not limited to, cell phones, PDAs, laptop computers, mainframes, workstations, servers, processors or a segment of a processor, etc. Such computers or devices can be adapted to generate computer displays, receive user inputs, interact with graphical information, cause the transfer of cash, trade fund shares, and cause the printing of information, as examples. In some embodiments, handheld devices may also be used to collect data and/or calculate indexes, also optical character reader (OCR) devices and properly adapted scanners may be used to collect such data. Data may be pushed to or pulled from the various systems and subsystem described herein.

System functionality and databases may be co-located or distributed across many systems, subsystems, processors, and storage devices, which may collocated or remote to each other, including user devices and data sources. When remote to each other, communications between various systems, subsystems, processors, and storage devices can be accomplished using wired or wireless communications, over one or more of a variety of types of networks, including the Internet, World Wide Web, local area network, wide area network, virtual private network, and the like. Such networks can include a variety of computer systems, servers, and data storage devices, satellites, cellular networks, cable networks, telephone networks, and the like. Similarly, functionality and data of other relevant entities may be embodied in program code, resident in any of a variety of storage devices or systems and executed or accessed by any of a variety of processors.

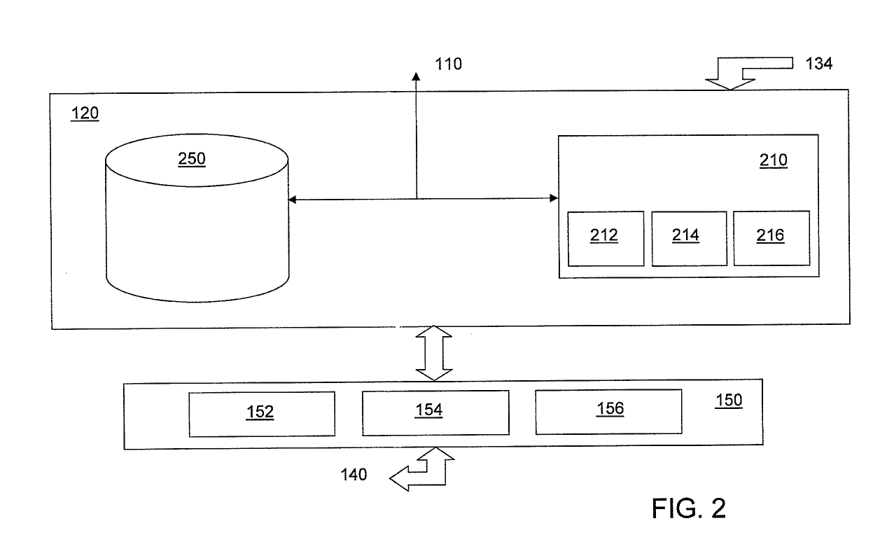

FIG. 2 is a block diagram of an embodiment of elements of the architecture of FIG. 1. Functional elements and modules can be embodied in many different forms, such as hardware, software, firmware, or some combination thereof. To the extent that functions are wholly or partly embodied in program code, those functions are executed by one or more processors that, taken together, are adapted to perform the particular functions of the present invention, to perform one or more particular machines. The program code and data may be stored in any known form of computer storage device or system.

Throughout the processing of various system functions and data, various data elements (e.g., values representing cash in investment accounts) are transformed, e.g., through indexed-based adjustments of the cash accounts and values, movement of cash values from system to system (which is an electronic representation and transformation of tangible cash assets), graphical representations of cash accounts and values, and transformations of fund performance and cash data into various graphical representations (e.g., bar graphs, pie charts, plots of values over time, and the like).

In embodiment of FIG. 2, the manager system 120 includes a uniquely adapted inflation indexing processor 210. Manager system 120 also can include a data storage system 250. The data storage system 250 can store parameters, data, and information for the various embodiments discussed above. That is, the data storage system 250 stores data the processor 210 accesses, manipulates, operates on, transforms, outputs, and communicates to or receives from other systems or devices.

For example, inflation indexing processor 210 can include a liquidity processor 212 adapted to determine and track liquidity provided to an entity, whether full or partial upfront liquidity. An inflation component processor 214 obtains the appropriate CPI and or CPI components from the received CPI information 134 needed to perform indexed adjustments to all or part of a payment stream of an entity. Payment adjustment processor 216 performs payment adjustment calculations by applying the appropriate index, which is generated from inflation values (or CPI values), to account information from data storage system 250.

In some embodiment, the payment stream could be adjusted using the inflation index to effectively result in an interest rate needed to maintain an amortization rate. This can be accomplished by the inflation indexing processor 210, e.g., by the payment adjustment processor 216.

The manager system 120 can communicate with client system 110, as described with respect to FIG. 1. In embodiments where there are inflation indexed payment streams aggregated into a fund, the manager system 120 can also communicate with fund system 150. Fund system 150 forms a fund and can define shares as claims against the fund. The fund system 150 can include an aggregator 152 that aggregates inflation indexed payment streams into a fund. A trading module 154 can manage the issuance and/or trading of shares against the fund. A value module 156 can continually or periodically calculate the value of the fund and its shares.

In various embodiments, fund system 150 can be accessed by investors 140, using an electronic computing device. The user's interaction, depending on the embodiment, can include accessing information about the fund and/or an account representing the user's investment in the fund. Such interaction could include outputting at the user device representations, whether textual, graphical, or otherwise, of the fund's performance, share price, fund value, fund analysis information, and so on.

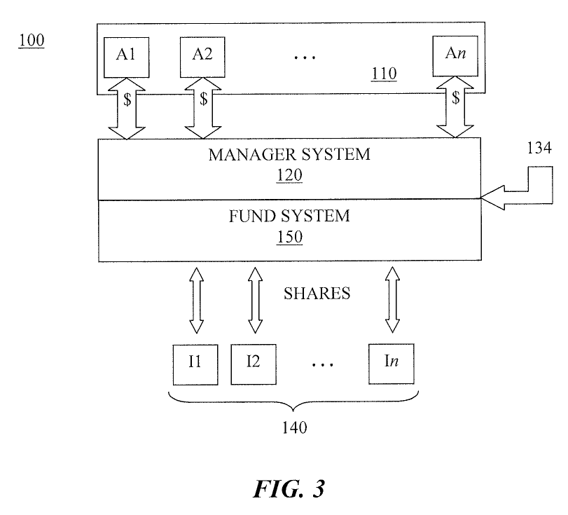

FIG. 3 shows a block diagram of an embodiment of an inflation indexing system 100 with the formation of a fund managed by a fund system 150, in accordance with aspects the present invention. Each entity (A1, A2 . . . An) receives liquidity and agrees to make payments (a payment stream) back to the manager system 120 and/or fund system 150, indicated by the double arrows “$.” The payment streams are indexed by at least one component of inflation, indicated by arrow 134. For example, in some embodiments, the inflation index could be CPI or one or more components thereof. In other embodiments the inflation index could be a custom index that is representative of inflation, which can be broadly or narrowly defined.

The fund system 150 can issue shares for trading with investors I1, I2, . . . In. The shares can be traded publicly, such as on an exchange, and/or privately a. Entities grouped in a fund, e.g., A1, A2, . . . An, can be indexed to inflation in the same way or in different ways. That is, inflation index 134 need not be the same for adjusting each payment stream. Also, even if inflation index 134 is a single index, e.g., CPI, it could be applied to each payment stream in a different way. That is, the payments streams for entities A1, A2, . . . An need not have the same payment stream index, or payment terms.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. An inflation indexing system, comprising:
an inflation indexing processor adapted to calculate a payment stream from a set of information including a stored initial liquidity value or balance;
an inflation component processor configured to retrieve one or more inflation components and to generate an inflation index therefrom; and
a payment adjustment processor configured to adjust the payment stream or balance using the inflation index.

2. The system of claim 1, wherein the initial liquidity value represents an upfront liquidity provided to an entity represented in memory.

3. The system of claim 2, wherein the payment stream represents at least one other payment to be distributed after the upfront liquidity.

4. The system of claim 1, wherein the one or more inflation components includes a single component representing CPI.

5. The system of claim 1, wherein the one or more inflation components is a plurality of CPI components.

6. The system of claim 1, further comprising:
a fund system configured to logically aggregate inflation indexed payments streams into a fund.

7. The system of claim 6, wherein the fund system is adapted to define shares as claims against a value of the fund.

8. The system of claim 7, wherein the fund system is adapted to electronically trade at least some of the shares.

9. The system of claim 7, wherein the fund system is adapted to adjust the value of the shares based on changes in the inflation index.

10. The system of claim 6, wherein the fund system is adapted to determine a fund value.

11. A computer-based method that uses one or more computer processors to perform inflation indexing of a payment stream, the method comprising:
calculating the payment stream from a set of information including an initial liquidity value or balance stored in memory;
retrieving one or more inflation components and automatically generating an inflation index therefrom; and
adjusting the payment stream and balance using the inflation index as well as, possibly, a resulting interest rate needed to maintain an amortization rate.

12. The method of claim 11, wherein the initial liquidity value represents upfront liquidity provided to an entity represented in memory.

13. The method of claim 12, wherein the payment stream also represents at least one other payment to be distributed after the upfront liquidity.

14. The method of claim 11, wherein the one or more inflation components is a single component representing CPI.

15. The method of claim 11, wherein the one or more inflation components is a plurality of CPI components.

16. The method of claim 11, further comprising logically aggregating inflation indexed payments streams into a fund.

17. The method of claim 16, further comprising defining shares as claims against the value of the fund.

18. The method of claim 17, further comprising trading at least some of the shares.

19. The method of claim 17, further comprising adjusting the value of the shares based on changes in the inflation index.

20. The method of claim 16, further comprising determining a fund value.
